(19) United States
(12) Patent Application Publication
(10) Pub. No.: US 2009/0273180 A1
(43) Pub. Date: Nov. 5, 2009

(54) Pipe Connector

(76) Inventors: Steven Lavalle, Bayville, NY (US); Greg V. Johnson, Bayville, NY (US)

Correspondence Address: PRYOR CASHMAN, LLP, 7 Times Square, NEW YORK, NY, 10036-6569, US

(21) Appl. No.: 12/113,308

(22) Filed: May 1, 2008

(51) Int. Cl. F16L 55/00

(52) U.S. Cl. 285/10

(57) ABSTRACT

A plumbing connector for connecting plumbing pipe includes a housing having an inner surface substantially conforming to an outer surface of a plumbing pipe. A glue channel is formed within the housing, near to its open end, and located along the inner surface of the housing. A glue filling inlet is formed through the housing and accessible from the outside of the housing in fluid communication with the glue channel, the glue filling inlet being adapted to allow glue to pass therethrough and into the glue channel. Preferably, at least one air escape outlet is formed through the housing and in communication with the glue channel. When the housing is mounted on a pipe segment and glue is introduced via the glue filling inlet, air trapped inside the glue channel exits via the air escape outlet. A transparent section of housing or a window is preferably provided above the glue channel.

### BACKGROUND OF THE INVENTION

1. Field of the Invention

The present invention relates to plumbing connectors utilizing glue or adhesive to create a fluid tight or mechanical joint with connected piping elements. More specifically, and in the preferred embodiment, the present invention relates to a method and mechanism for quickly and economically connecting plumbing or conduit components, which is efficient, simple and provides visual marking to determine that the adhesive connection has been accomplished.

2. Description of Related Art

Water- and other material-carrying pipes are used in home and office plumbing systems and must be strong, noncorrosive, and durable enough to equal or exceed the expected life of the building in which they are installed. These pipes can also be used for cable wiring, telephone lines, electrical conduit, etc. Ordinary water pipes are usually made of steel, copper, brass, plastic, or other materials. The most common materials for sewage pipes are cast iron, steel, and copper. Recently, PVC pipes have become a very popular alternative to metal pipes because of their ease of installation, they are lightweight, and can be quickly cut to appropriate length. The PVC pipes and their associated connectors are inexpensive, (as mentioned, relatively light-weight) easy to work with, and non-corrosive and, therefore, can be used for the outside as well as the inside plumbing and as other conduit. They, too, are expected to be long lasting, fluid tight and mechanically strong.

Depending on the material used for the pipes, different types of connections to form extended runs of piping and piping turns and connections can be used and implemented. Copper pipes are typically inserted into copper connectors, sometimes called couplings, and welded together by any conventional welding or soldering method. Some waste plumbing has standard screw threads located on the outside of one end of each pipe and corresponding screw threads on the inside of their connectors so that each pipe can be mechanically screwed into its connector. Another possible connection of metal pipes is shown in FIG. 7, representative of the prior art, where a pipe 100 is inserted into a connector 104, which has a metal band 102 extending around the connector 104. A screw pin 106 can be turned to reduce the length of the metal band 102, thus forming a very tight bonding between the pipe and the connector which is slid beneath the band. Automobiles use similar connectors for hoses to inlets and outlets.

PVC pipes cannot be effectively connected by any of the above described methods. They cannot withstand the pressure of being tightened by a cinching connector nor can they be welded. The use of screw threads on the ends of the PVC piping makes cutting of the pipes to exact length difficult and it is also difficult or expensive to provide the screw threads for an appreciable length of piping so that cutting can be done. Also, a screw-type connection may not be fluid-tight nor durable enough on its own. Also the ease of use of PVC requires that the pipes often be cut in length. Thus, pre-existing threads at the ends of the pipe will be cut off. As a result of the above, presently, the only way to connect PVC pipes is to glue or bond them to the connector. The connection of PVC piping to the proper connector, whether it be a length connector, an elbow, a T-shape, etc. is currently a multi-step process, which typically starts with measuring a necessary length of the pipe and cutting it to the proper length for the particular application. After cutting it to a desired length, the installer assembles the pipe to the proper connector, a T-shape, an elbow for a turn, a 45 degree connector or a simple pipe extender (for pipe length to pipe length) to see whether the assembly will fit and is appropriate for the desired application. If no more cuts or fittings/connectors or adjustments are needed, the installer will then disassemble the pre-formed pipes and associated connections, one connection at a time, apply cleaner/primer to the pipe and the connector, then brush a special PVC adhesive/bonding agent/glue on the outside of the end of the pipe and the inside of the connecting end of the connector, and replace the pipe end into the connector. There, the adhesive/bonding agent/glue will dry and the two components will fuse to for a more permanent bonding.

This process is inconvenient because the installer has to spend time disassembling a fully assembled set of connections only to apply the adhesive or bonding agent and reassemble the connection again. When disassembling, connection by connection, more than that particular connection may become loose and fall apart. The laborer then needs to reconnect the pieces and this can be time and labor intensive, in addition to frustrating. Moreover, considering the fact that the PVC adhesive or bonding agent/glue takes about three seconds to set, the process can be difficult and/or wasteful because, once the glue has been applied, the pipe has to be used and connected to the connection immediately, otherwise the adhesive process is not effective. Additionally, the process is unsafe because it may expose the installer to the fumes of the alcohol-based PVC glue, which is a health hazard. Moreover, there is a definite possibility that the laborer/plumber will forget to glue one or more connections or joints in an assembly, thereby creating an excellent chance of a leak or the assembly coming apart. Also, with the prior art mechanism for connecting PVC pipes and connectors together, a Building Inspector needs to physically touch or run a water-tightness test to ensure that all pipes are secured to and within all connections. A visible means for ensuring that pipes are connected to and within their connections would be beneficial. A mechanism and system for ensuring that pipes and connectors are connected, once and securely, and without the need for disassembly of the components is highly desired. The present invention provides the solution to these and other disadvantages of the prior art.

Accordingly, there is a long standing interest in the art for a PVC or plastic pipe and connector mechanism which eliminates the necessity of disassembling the connection to apply the adhesive/bonding agent or glue, while protecting the installer from hazardous fumes. There is also a need in the art for a quick, non-manual process of applying the adhesive to the pipe and connectors. There is also a need in the art to provide a mechanism which, when finished, provides a visual cue to the completion of the process to both the laborer and/or a building inspector.

### SUMMARY OF THE INVENTION

The invention fulfills the above and other long-felt needs in the field, and is a plumbing connector for connecting and securing to plumbing pipe segments. The invention includes a connector-like housing having an inner surface substantially conforming to an outer surface of a plumbing pipe. A glue/adhesive or bonding agent (collectively “glue”) channel is formed within the housing and located along and around the inner surface of the housing. A glue filling inlet is formed through the housing and accessible from the outside of the housing and is in fluid communication with the glue channel, the glue filling inlet being adapted to allow glue to pass therethrough and into the glue channel. Preferably, at least one air escape outlet is formed through the housing and is in communication with the glue channel. When the housing of the connector is mounted on an end of the pipe and glue is introduced via the glue filling inlet, the glue will be contained within the glue channel and will serve to adhere the pipe to the connector. The air trapped inside the glue channel will exit via the air escape outlet as the glue fills in the gap provided by the glue channel, between the outside of the pipe wall and the inside of the surface of the housing forming the glue channel. A transparent section of the housing or a window is preferably provided so that the contents (initially air but then glue) can be seen within the glue channel.

In general, the process of connecting PVC pipes is very time consuming. It requires an installer to measure the necessary length of a pipe, cut the pipe to this desired length, assemble the pipe with a pipe connector (a 90° bend, a “T” joint or elbow, for examples) to see if they fit, then take them apart, manually apply a necessary amount of PVC glue to both the outside curved wall surface of the pipe and the inside curved wall surface of the connector and reassemble the pipe and its connector back together to form a secure joint. In effect the installer is connecting the pipe elements twice. In addition, the installer/plumber must hold the pipe and connector element together during the gluing operation to prevent “push-out,” the gradual outward sliding of one component vis a vis another during the initial phase of the gluing operation.

In accordance with the preferred embodiment of the present invention, a PVC plumbing pipe connector is provided which, instead of being smooth-walled on the inside, has a cavity, as a glue channel, around and along its inner perimeter. This gap or spacing between the inside wall of the connector and the outside wall of the pipe to be held within the connector provides a channel or cavity. The channel can be accessed from the outside of the connector and filled with a required amount of glue, without first disassembling the plumbing pipe and the connector. Thus, the present invention accomplishes the above stated objectives, including elimination of the disassembly step from the process of joining PVC pipes. This can result in huge manual labor and time savings.

In accordance with another embodiment of the present invention, the manual application of glue to the pipe components is eliminated. The glue can be provided to the glue channel, via the glue filling inlet by use of a glue gun which attaches to the glue filling inlet. The glue gun can be mechanically similar to a grease gun for automobiles or to a caulking gun as used in the insulating field. The glue, within a cartridge, is transmitted from the gun, through the glue filling inlet and into the channel of the housing of the connector. There, the glue will be maintained within the channel as it wraps around the PVC pipe and, in this manner, the glue will bond the connector to the pipe.

In an alternate embodiment, a glue-filled wax-paper ring is preinserted into the pipe connector. As soon as the pipe and connector is ready for bonding, a sliding collar positioned on the pipe is pushed fully inside an extended flange of the connector and against the wax-paper ring. The compression of the sliding collar against the ring causes the ring, with the glue contained therein, to burst open, under pressure, and the glue then seeps around and fills the glue channel or gap between the pipe and the connector, solidifying and forming a bonded joint.

Another benefit of the present invention is the elimination of the time-consuming step by the plumber/installer of pipe to hold the connector to the pipe once the glue has been injected. According to the prior art manner of installing PVC piping, when the installer pushes the pipe into the fitting, for gluing, there is a spring-like effect, a forcing outwardly of the pipe vis a vis the connector, created upon first contact of the leading edge of the pipe with the glue on the connector. If the installer does not securely hold the fitting to the pipe during the drying of the glue, during securing, the spring-like effect will push the pipe almost completely out of the joint. Use of the present invention, on the other hand, eliminates the pushing out or spring-like effect and also decreases the time for doing the adhering operation.

In the prior art manner of connecting PVC pipe to associated connector, if the installer forgets to apply glue to one or more of the connections, he has no alternative but to begin a oft-frustrating and certainly time consuming procedure of cutting away and removing the “dry joint.” Often the procedure demands an extra connection utilizing a coupling immediately adjacent the coupling being repaired. According to the present invention, however, if the installer notices that he has failed to glue a pipe to a connection, he can simply and quickly (and without added connections) go back to the joint and apply the glue through the fitting and into the channel just as easily as if he had done so the first time.

According to the present manner of verifying that all connections are glued or adhered together, the installer or inspector will run water through the piping system and look for leaks. According to the present invention, however, all connections can be easily and quickly verified as having been made by a simple visual inspection of each connection and, specifically, a “look” by the plumber or inspector at the air-escape hold of the connection. If a small amount of adhesive or glue sits atop the escape hole, then the joint has been glued since glue, to sit atop the escape hole can only form there by first passing around the pipe and connector and then the excess glue will seek to exit the channel through the air-escape hole.

According to the prior art manner of securing pipe to connectors, adhesive is first swabbed or brushed onto the end of the pipe and the inside of the end of the connector. Then, the two pieces are manually manipulated with the pipe being pushed into the connector and held there during drying. The delay between the glue application to one element and the application to the other element can result in partial air drying before the pieces are placed into proper orientation. This is clearly undesirable. According to the present invention, however, the glue or adhesive is applied simultaneously to both pipe and connector.

According to the prior art manner of connecting PVC pipe and connectors, adhesive is swabbed or brushed on to the elements in generous quantities to ensure a sufficient amount is available for the adhesion. Alternatively, insufficient quantities may be provided to one element or the other or to both, providing insufficient water-tightness to the formed joint. The present invention, however, ensures the precise and proper amount of glue application—approximately 50% less than those situations where installers generously and unnecessarily swab or brush too much adhesive. Also, by eliminating too much glue for a particular joint, the time waiting for the glue to dry is minimized in comparison to the time waiting for glue to dry in those situations where the installer swabs or brushes too much glue than is necessary for the joint. The present invention thus conserves the glue composition and is cost effective and saves in labor and time. Also, in the current manner of securing PVC piping, i.e., by brushing both the pipe and its connector with the adhesive or bonding material, some of that material is pushed inside the connector as the pipe's leading edge pushes the adhesive ahead of it and some of the adhesive is pushed over the outside edge of the pipe, too. The former provides a restriction on smooth liquid flow within the system and the latter is either unsightly or requires a wiping off by the installer of the excess glue material.

According to the prior art manner of connecting PVC pipe to connectors, the swabbing and brushing of the adhesive to the free end of the pipe and the inside of the opening of the connector results in high concentrations of fumes. This, especially in small spaces, can be overwhelming to the installer and is perceived as a short and/or long term potential health risk. The daily doses of concentration of the fumes from the air-exposed glue can lead to light-headedness, too, and can lead to periods of ineffective work. Of course, the release of the fumes into the environment can be deleterious, too. According to the new invention disclosed herein, the fumes released to the air is minimized since substantially all glue is maintained within a channel, between the outside of the pipe and the inside of the connector, with only a very small amount of glue (at the air escape hole) actually reaching air. This, too, is a perceived advantage to the present invention.

### BRIEF DESCRIPTION OF THE DRAWINGS

FIG. 1 is a perspective view of a plumbing connector (90° elbow) according to one embodiment of the present invention.

FIG. 2 is a top view of a typical pipe connection (again, a 90° elbow), where two plumbing pipes (partially shown) are joined together through the plumbing connector, the subject of the present invention.

FIG. 3a is a cross-sectional view of the arrangement shown in FIG. 2, taken along line A-A.

FIG. 3b is a cross-sectional view of the same type of arrangement shown in FIG. 2, taken along line A-A, where the glue channel is internally grooved to allow for additional near-zero tolerance surface area.

FIG. 4 is a side view of a glue injector which can be used with the present invention.

FIG. 5 is a front view of the glue injector shown in FIG. 4.

FIG. 6 is a perspective cross-sectional view of another embodiment of the plumbing connector, in accordance with the present invention.

FIG. 7 is a perspective view of a method and mechanism for the prior art connection of metal pipes.

FIG. 8 is a cross-sectional view of the second embodiment of the present invention showing an alternative configuration of the glue-containing means.

FIG. 9 is a front and a side view of an alternative embodiment of the glue injector in accordance with the present invention.

FIG. 10 is a top view of an alternative embodiment of the filling inlet.

FIG. 11 is a partial perspective view of the embodiment of the filling inlet depicted in FIG. 10.

FIG. 12 is cross-sectional view of another embodiment of the pipe fitting of the present invention.

### DETAILED DESCRIPTION OF THE INVENTION AND DRAWINGS

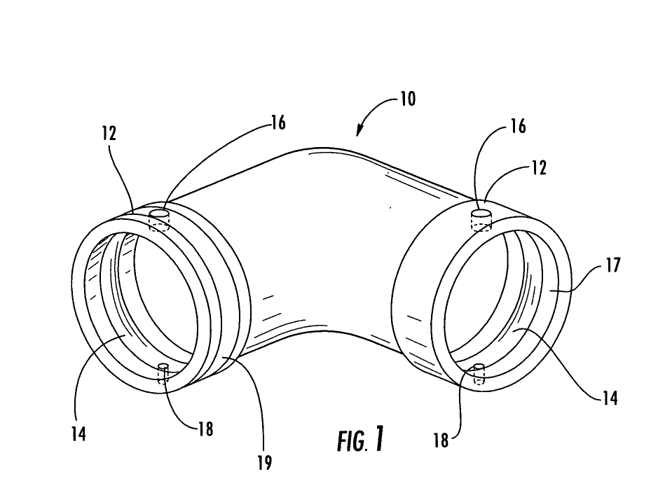

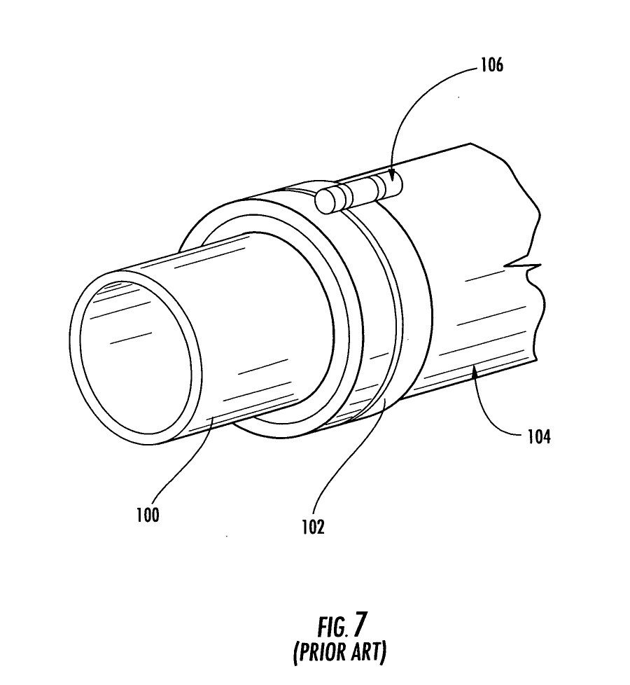

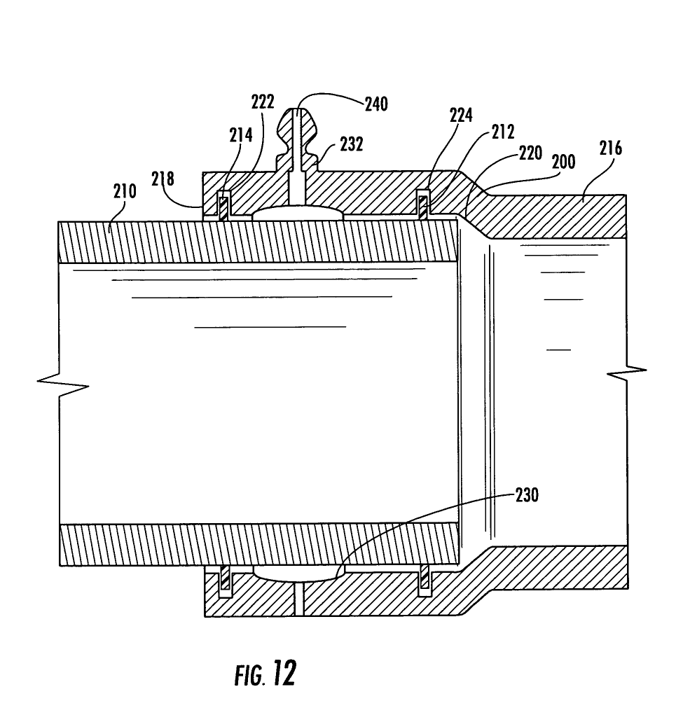

Description of the invention will now be given with reference to FIGS. 1-11. It should be understood that these figures are exemplary in nature and in no way serve to limit the scope of the invention, which is defined by the claims appearing hereinbelow.

A plumbing connector according to one embodiment of the present invention is generally indicated by the reference number 10 in FIG. 1. In this embodiment, the connector is shown as a 90 degree elbow, but, of course, it can be a 45 degree, an end cap, a T-shaped connector, even a connector for connecting two parallel and aligned pipe segments to lengthen the overall run of pipe, etc. Here, however, with the embodiment shown as a 90 degree bend, there are two connector ends shown and illustrated.

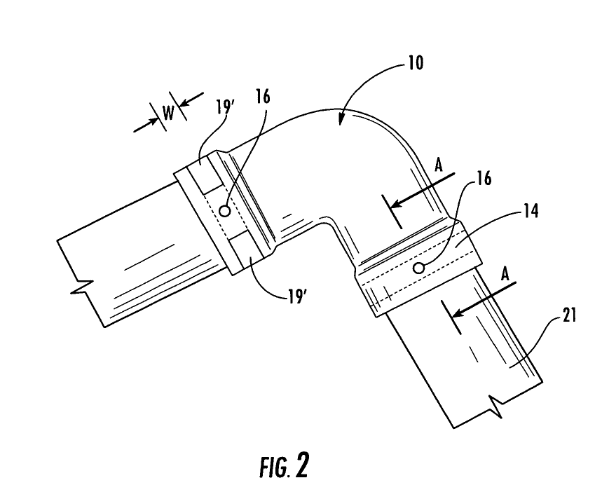

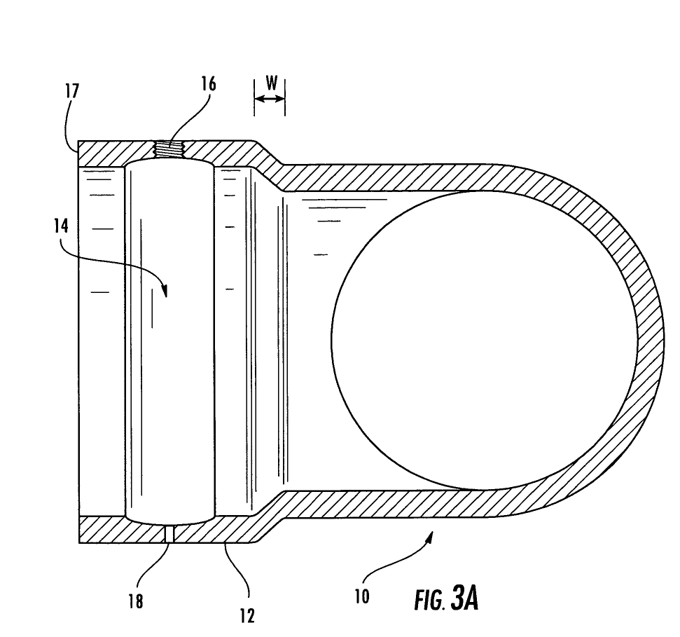

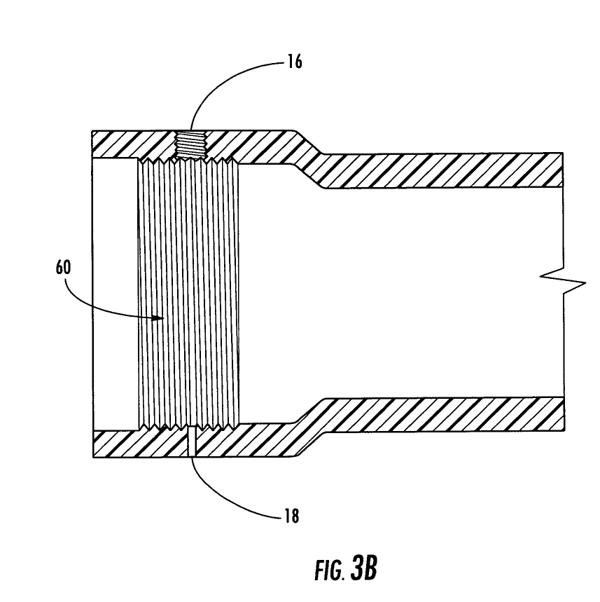

As shown in FIG. 1, the first embodiment of the present invention eliminates the need for disassembling a pipe connection that has preliminarily been pre-assembled when an installer is ready to bond the joint. It is accomplished by a design of the elbow connector 10, comprising a housing 12, where the housing has a glue channel 14 along and around its inner cylindrical wall. The channel is a small ring-like gap formed or cut into the inside wall of the connector such that its diameter is slightly greater say, ⅛ of an inch, than the outside diameter of the pipe segment which is intended to be fit and bonded thereon. The channel is recessed from the end 17 of the connector and is a width, “w.” At the inside edge of the channel, the inside diameter of the connector 10 is substantially the same as the outside diameter of the pipe segment, just as it is at the end 17 of the connector. When a connecting pipe is inserted into the housing of the connector, after a suitable cleaner/primer has been applied to both the pipe and the connector, the bonding process can be easily accomplished without the necessity of first disassembling the components. The glue channel is provided with an access port 16 which terminates on the outside of the connector, i.e., on its outside cylindrical wall 12. The glue channel 14 is filled with glue from the outside through the access port 16, a glue filling inlet formed through the housing 12. This can be formed by drilling, for example, or by any other convenient process. In an alternate embodiment, the access port or glue filling inlet 16 can be a nipple or a grease-fitting like device which allows for a grease gun to selectively attach for inserting, under pressure, the adhesive or glue, within a cartridge, into the channel by having the glue pass through the glue filling inlet or the nipple. To facilitate the distribution of the glue around the entire pipe segment, between the inside wall of the channel of the connector and the outside wall of the pipe segment, and to allow the air trapped inside the glue channel 14 to exit, an air escape outlet 18 (a small bore or opening) is formed extending entirely through the housing and also connecting the glue channel and the outside air. The air escape outlet is preferably about 180° around from (or otherwise opposite) the glue filing inlet 16, as shown in FIGS. 1 and 3a. The glue, forced through the inlet 16, will flow in the glue channel 14, contained between the edges of the channel (where the inside wall of the connector is about the same dimension as the outside wall of the pipe segment) and thus over the outside of the attached pipe 21. A portion of the glue will seep from the channel and aid in the bonding process. See FIG. 2. This adhesive or glue will thus bond, upon time or curing, the connector and its housing to the pipe segment.

Alternatively, grooves or threads 60 (see FIG. 3b) can be supplied to the inside of the glue channel 14. In another version, grooves or threads can also be supplied to the outside of the pipe segment. Thus, in the embodiment where only grooves are supplied on the inside of the connector, the glue will spread over the surface of the smooth-walled pipe. In the alternate embodiment where grooves or threads are also provided on the outside of the pipe, the installer will first apply the cleaner/primer, then partially or completely screw the connecting pipe into the connector, and then inject the glue into the filling inlet 16. The glue will evenly flow along the threads 60 over the pipe 21 (which in one embodiment is facilitated by screwing the pipe into the connector), further securely bonding the pipe with the connector. In addition to making the bonding process easy, this design will confine the glue distribution to the area of the glue channel, resulting in more efficient use of glue. Use of the connector having grooves and a smooth-walled pipe should be clear. In the embodiment where only the connector is internally grooved, the peaks of the grooves provide additional areas for surface contact with the outside of the pipe and, yet, the walls of the glue channel prevent the glue from seeping out, i.e., the glue is retained within the channel.

The same advantage can be realized by applying threads 60 to the glue channel only, i.e. without applying threads to the pipe. Then, the smooth walled pipe 21 is simply inserted into the connector 10, and the glue, when inserted through the flue filling inlet is distributed around the pipe segment, along the threads 60. Again, the air outlet allows for the adhesive to distribute about the pipe segment. When the laborer sees the glue at the air outlet, he/she knows that the glue insertion step is complete in that the glue has extended fully around the pipe segment, within the channel of the connector, and, upon drying or curing, an effective bond between the components is provided.

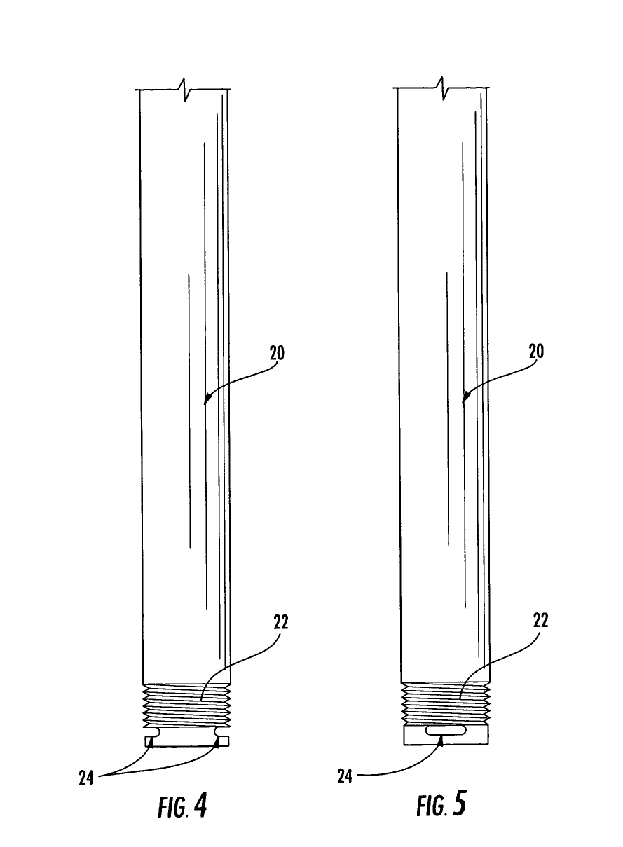

The inner surface of the filling inlet 16 can be threaded to allow a tube-shaped glue injector to be selectively screwed into the inlet 16. A specially designed glue injector 20 can be used in connection with the present invention. An alternative embodiment is shown in FIGS. 4 and 5, having two openings 24 on the opposite sides of the threaded screw-end 22. This design will allow glue to flow evenly in both directions. Additionally, since glue is injected directly into the filling inlet 16 and is substantially contained within the glue channel, the installer's exposure to harmful fumes is minimized.

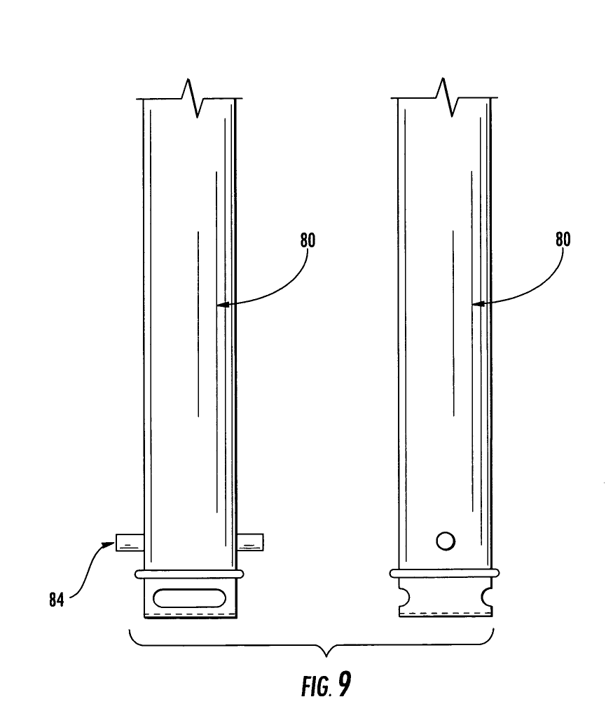

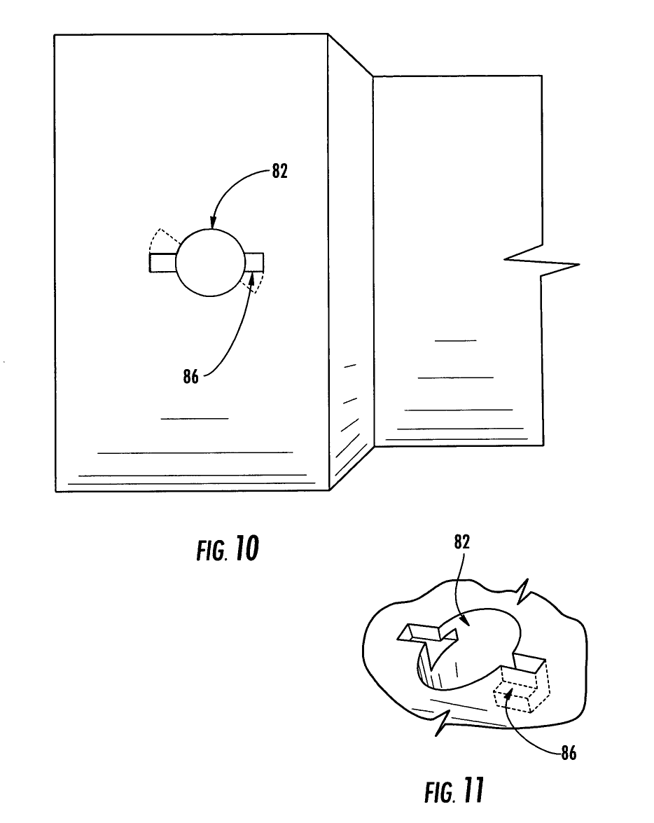

Alternative embodiments of a glue injector and filling inlets are shown in FIGS. 9, 10 and 11, where the alternative embodiment of the glue injector is generally indicated by the reference number 80 and the alternative embodiment of the filling inlet is indicated by the reference number 82. In this embodiment, the glue injector 80 is equipped with a set of retaining prongs 84 which can be inserted into the correspondingly-shaped twist-lock slots 86 located, as shown in FIG. 10, within the body of the connector along the sides of the filling inlet 82. When the plumbing system is ready for connection, an installer will insert the glue injector 80 into the filling inlet 82 in such a way that the retaining prongs are inserted into the twist-lock slots 86, and then twist the injector to lock it inside the filling inlet.

The plumbing connector 10 and specifically a section of the connector located at the channel can be made partially transparent to enable an installer to see the flow of glue into the channel 14. For example, as shown in FIGS. 1 and 2, housing 12 is preferably provided with a transparent portion or window 19 at or near at least a portion of glue channel 14. In FIG. 1, window 19 substantially circumscribes the entire housing 12 above glue channel 14, for full viewing from the outside of the interior of glue channel 14. This allows the user to fill the glue channel either partially or fully as he or she desires and for the laborer (or inspector) to visually see that the bonding material, i.e., the glue, a) has been inserted into the connector and b) has extended substantially around the pipe segment to adhere and glue the elements/components together in a likely fluid-tight manner. Alternatively, as shown in FIG. 2, at least one partial window 19′ may be provided at a portion of housing 12 sufficiently remote from the glue inlet 16 that one can determine that sufficient glue has entered channel 14. In one embodiment, a single window 19′ is provided substantially at or near air escape outlet 18, which is preferably on the opposite side of housing 12 from glue inlet 16 (i.e., substantially 180° around from glue inlet 16). Other variations in the size and location of window 19 or 19′ may be employed without departing from the scope of the invention. Indeed, a window need not be provided at all. In such case where connector 10 has no window or transparent portion, the user may preferably inject a sufficient quantity of glue into the channel 14 until glue begins to emerge from outlet 18.

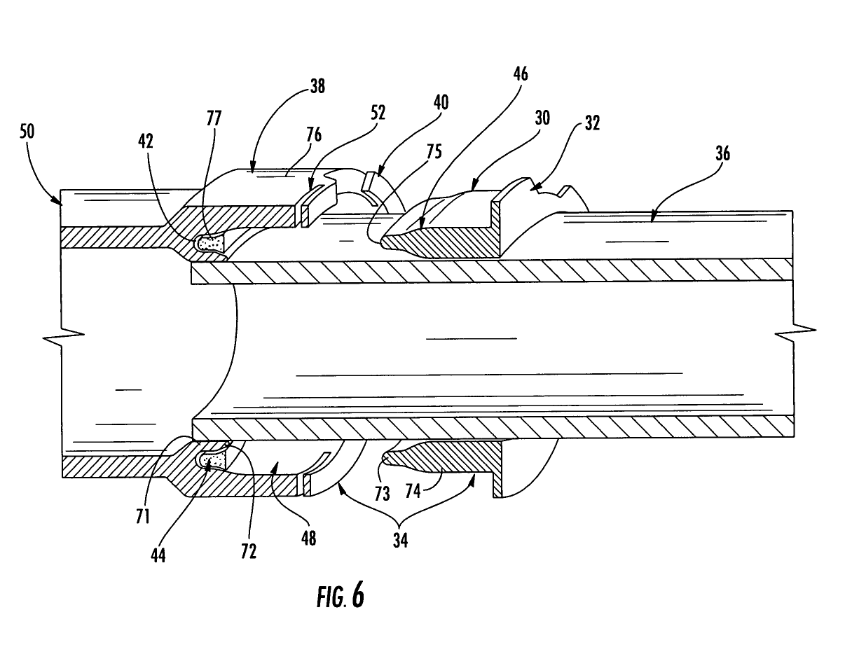

A plumbing connector according to another embodiment of the present invention is generally indicated by the reference number 50 in FIG. 6.

As shown in FIG. 6, another embodiment of the present invention eliminates both the need for disassembling and the need for manual application of glue to the connector and the pipe. In this embodiment, the fluid-tight and mechanical connection is accomplished by a twist-locking mechanism 34.

As shown in the drawings, secured about an ordinary segment of plumbing pipe 36, is a slidable collar 30, which has a male member 46 extending along the length of the pipe segment and toward the connector 50. The slidable collar 30 has a plurality of flange sections 32 outwardly and radially extending from its body. The inside diameter of the slidable collar 30 is slightly greater than the outside diameter of the pipe segment to allow for easily sliding the collar over the open end of the pipe segment and then for sliding the collar down toward the connector when secure connection of the elements is desired. Prior to assembly and gluing, the collar is slid over the open end of the pipe segment sought to be connected to the connector element 50. A connector housing 38 is provided with an internal flange piece of an inside diameter just greater than the outside diameter of the pipe segment. This flange piece 71 extends along the longitudinal axis of the connector and has a point 72 which slides under and behind the flange 73 of the sliding collar. As can be seen in FIG. 6, the flange 73 is greater in inside diameter than the outside diameter of the main body 74 of the sliding collar 30. Thus, a gap 75 is defined between the flange 74 and the outside wall of the pipe segment. Here, too, the connector is any one of a number of standard connectors, e.g., an elbow, bend, T-shape, end cap, in-line connector, etc. Also in this embodiment, a channel is formed between the outside surface of the flange 71 and the inside wall of the body 76 of the connector. The U-shaped channel 77 of the connector housing 38 extends upwardly and forms a female opening 48 for the twist-locking mechanism 34 of the sliding collar 30. The female opening corresponds in its shape to the shape of the male member 46 of the sliding collar 30. As a result, the male member 46 can be slidably inserted into the female opening 48 of the housing 38, after the plumbing pipe 36 is first inserted into the connector 50 and the sliding collar forced towards the connector. In this manner, the tip 73 of the flange 74 will extend into the U-shaped channel 77, with the tip 72 of the flange of the connector being held behind the tip 73 of the sidable collar 30, i.e., within gap 75.

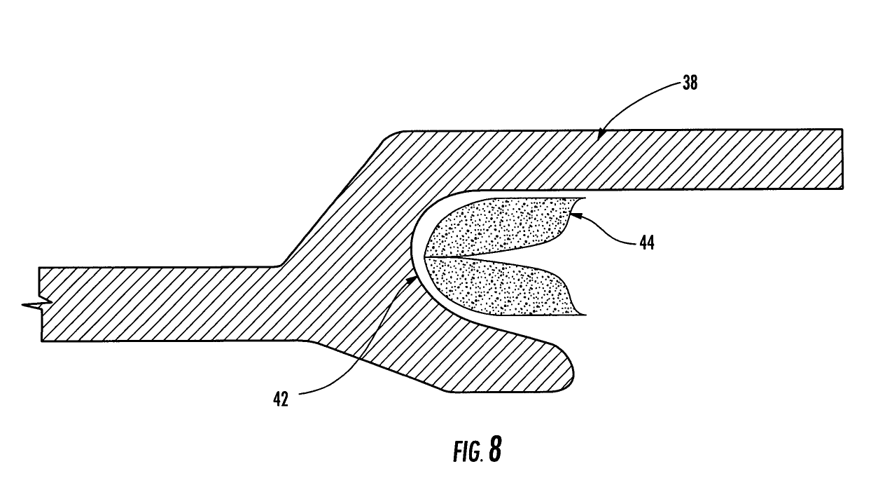

As shown in FIG. 6, the connector housing 38 has an annular cavity 42, at the far end of the female opening 48, corresponding in shape to the end portion of the male member 46. A glue-filled wax-paper ring 44, or other glue containing envelop or means, can be pre-inserted into the cavity 42, so that the wax-paper ring can be later broken by the inserted male member 46, when pressure is supplied by the laborer to force the sliding collar into the connector. The tip 73 of the flange 74 will break the seal of the wax paper ring and cause the glue contained therein to seep between the plastic components. The glue will cure or dry and thus result in a liquid tight seal of the components. The glue-containing means 44 can also be made of aluminum foil or any other suitable material which has integrity until pierced or broken at which point the glue is released. Additionally, the gluing mechanism, the shape of the paper ring filled with glue, can be constructed in a way shown in FIG. 8 to facilitate equal glue distribution along inside and outside surfaces of the pipe segment to the connector. The glue is intended to seep between the outside of the flange of the collar and the inside of the portion 76 of the connector and, in addition, between the outside of the pipe segment and the inside of the flange 71. Also, some glue will secure the inside edge of the tip 73 to the outside of the flange tip 72. The entire construction is substantially water tight, upon curing and drying.

The connector housing 38 also has a plurality of flanges 40 which are extended from the body of the housing toward the sliding collar 30 and bent into an “L”-shape with a resulting gap 52 between each “L”-shaped flange and the body of the housing 38. As shown in FIG. 6, these “L”-shaped flanges 40 are located along the outside rim of the female opening 48 in such a way that the more outwardly extending portions of the flange sections 32 of the sliding collar 30 can advance into the openings 52 of the “L”-shaped flanges 40. This provides further mechanical and structural security.

After the pipe 36 is inserted into the connector 50, the sliding collar is forced toward the connector housing. This will cause the ring 44 of glue to burst and release the glue. The collar is then turned to secure the flange sections 32 within the openings 52 of the “L”-shaped flanges 40. This will hold the pieces together and ensure the drying/curing of the adhesive, now released from the ring. The sliding collar 30 can be rotated to force each flange section 32 into the slot 52 (in a bayonet-like connection) between the body of the housing 38 and one of the “L”-shaped flanges 40. This will ensure that the sliding collar 30 keeps its position stable as the glue dries.

During the installation, when the pipe 36 and its connector 50 are tried for their fit, the sliding collar 30, the flanges 40 and 32 should be positioned in such a way as to prevent the male member 46 from fully protruding into the female opening 48. Inadvertently allowing that to occur would likely prematurely cause the ring to burst and commence the curing and drying of the glue before the pieces are desirably connected. When, however, an installer assembles the plumbing pipe 36 with the connector 50 for a final connection, after the cleaner/primer has been applied, if required, the pre-positioned on the open end of the pipe segment-collar is then pushed into the female opening 48 and twisted to allow the flange sections 32 to advance into slots 52, i.e., between the “L”-shaped flanges, and, consequently to allow the male member 46 to be pushed into the glue cavity 42. The glue filled wax-paper ring 44 bursts under the pressure, and the glue is equally distributed along the outside perimeter of the pipe 36 and the inside wall of the flange 72. Glue will bond the pipe 36, the connector 50, and the collar 30. As shown in FIG. 6, the male member 46 and the female opening 48 are designed to allow some space between them to be filled by the glue. Before the glue sets in, the pipe 36 with its sliding collar 30 is turned to lock the twist-lock flanges 40 and 32. This, too, mechanically secures the pipe to the connector. It should also be understood and appreciated by those of ordinary skill in the art that there are a number of ways to secure the sliding collar 30 to the connector 50.

Plumbing pipes and connectors of all conventional diameters can be used with the present invention. Moreover, differently shaped PVC pipe connectors, such as “elbow 90,” “elbow 45,” end caps, “T” or “Y,” can be designed according to the embodiments of the present invention. As a result, any number of PVC pipes, that conventionally can be connected together, can be joined at different angles by these novel connectors.

As seen in FIG. 12, another embodiment of the fitting 200 is intended to provide a leak-proof fit to a pipe 210. The inside of connector 200 is provided with a pair of spaced apart, pliable (such as nylon or rubber) O-rings 212 and 214. The pipe fitting 200 has a section 216 whose internal diameter is slightly greater than the internal diameter of the standard pipe 210 to which it is intended to be attached. Proceeding from section 216 toward the open end 218 of the fitting is an outwardly flared wall 220 which takes the internal diameter of the fitting 200 from that of section 216 to an internal diameter greater than that of the outside diameter of the standard pipe 210. The open end 218 of the fitting 200 is provided with a pair of spaced notches 222 and 224 which are grooved into the inside surface of the open end 218 of the fitting 200 and are spaced apart the distance of the O-rings 212 and 214. The thickness and depth of the notches 222 and 224 are sufficient to allow the pliant O-rings to easily slip into the notches. In this manner the standard pipe 210 will, with the O-rings attached and spaced, easily slide into the open end 218 of the pipe fitting and then the O-rings will be located within the notches.

Located between the notches 222 and 224, on the inside surface of the open end 218 of the fitting 200 is a trigonometric sine-like, formed recess 230. The recess 230 extends around the entirety of the fitting. At the peak of the recess 230 is a conduit 240 which servers to provide access to the recess from the outside of the fitting. The conduit 240 can be provided with a stop-valve (a ball and spring) mechanism to ensure only one way flow of adhesive into the recess and through the grease-fitting or nipple 232 and eliminate the flow of adhesive out the conduit 240 through the nipple 240.

In use, the fitting of FIG. 12 is substantially similar to that of the other examples described and illustrated. The fitting 200 is slid over the open end 210 of a pipe to which it is intended to be connected. The connector, as mentioned, is first provided with a pair of O-rings or nylon washers 212 and 214 inserted into notches 222 and 224, respectively. Then, with the fitting in place over the end of the pipe, glue, adhesive, bonding agent, etc. can be introduced into the recess, by connecting a source of the same, like a caulking gun or grease gun, but loaded with glue, adhesive, bonding agent to the nipple 232. The use of the grease or caulking gun is not a part of the invention and its operation and use is believed within the scope of understanding of those of ordinary skill in the art to which the invention pertains. Pushing the glue, adhesive or bonding agent into the recess 230, through the conduit 240 of the nipple 232, provides the agent for adhesion between the outside of the pipe and the inside of the fitting. The passage of time will cure the glue, adhesive or bonding agent. The O-rings and the glue, when cured, will provide a water or fluid tight fit.

The outside of the fitting 200 can be provided with a transparent ring or a segment so that the user can quickly and visually determine that the glue, adhesive and/or bonding agent has been fully introduced into the recess.

The invention is not limited to the above description. For example, while PVC is specified as a material out of which pipe may be constructed that may advantageously utilize the invention, the invention will also be applicable for piping of any type or material for which gluing, adhesive, or contact bonding by one or two parts (or more) is appropriate. Further, all of the above piping is described and shown as circular in cross section; however, the invention is also applicable to piping with a polygonal or other shaped cross-sections.

Having described this invention with regard to specific embodiments, it is to be understood that the description is not meant as a limitation since further variations or modifications may be apparent or may suggest themselves to those skilled in the art. It is intended that the present application cover such variations and modifications as fall within the scope of the appended claims.

What is claimed is:

1. A plumbing connector for connecting plumbing pipe, comprising:
a housing having an inner surface substantially conforming to an outer surface of a plumbing pipe segment;
a glue channel formed within said housing and located along and around said inner surface of said housing; and
a glue filling inlet formed through said housing and accessible from the outside of said housing in fluid communication with said glue channel, said glue filling inlet being adapted to allow glue to pass therethrough and into and around said glue channel.

2. A plumbing connector as claimed in claim 1, further comprising at least one air escape outlet formed through said housing and in communication with said glue channel, wherein when said housing is mounted on a pipe and glue is introduced via said glue filling inlet, air trapped inside said glue channel exits via said air escape outlet.

3. A plumbing connector as claimed in claim 1, wherein said glue channel includes a set of internal grooves.

4. A plumbing connector as claimed in claim 3, further comprising a connecting pipe segment having external matingly engageable grooves with said internal grooves of said housing.

5. A plumbing connector as claimed in claim 1, wherein said filling inlet comprises internal threads, wherein said internal threads of said filling inlet are configured to allow a glue injector means having mating threads to be mated to said filling inlet.

6. A plumbing connector as claimed in claim 1 wherein said channel is slightly recessed from the end of the edge of said opening defining said housing.

7. A plumbing connector as claimed in claim 1, wherein said housing is at least partially transparent substantially at said glue channel forming a window for a user to determine the presence or absence of glue within said glue channel when viewing said window from the outside.

8. A plumbing connector as claimed in claim 2, wherein said air escape outlet is on an opposite side of said housing as said glue filling inlet.

9. A plumbing connector as claimed in claim 2, wherein said air escape outlet is approximately 180° away from said glue filling inlet.

10. A plumbing connector as claimed in claim 7, wherein said window wraps substantially entirely around said housing corresponding to said glue channel.

11. A plumbing connector as claimed in claim 7, wherein said window is disposed approximately 180° around from said glue filling inlet, thereby allowing the viewer to determine that said glue channel is completely filled with injected glue.

12. A plumbing connector as claimed in claim 1 wherein said glue filling inlet is provided with a one way valve.

13. A plumbing connector as claimed in claim 1 wherein said channel is about ¼ of an inch greater in internal diameter than the diameter of the opening of said connector.

14. A plumbing connector as claimed in claim 1 wherein said channel is recessed from the end of the connector.

15. A plumbing connector as claimed in claim 1 wherein said groove is sine-shaped.

16. A plumbing connector as claimed in claim 1 further comprising a pair of spaced notches, one on each side of said channel, for receipt of an O-ring, locatable on the outside surface of the pipe to which the connector is attached.
